(19) United States
(12) Patent Application Publication
(10) Pub. No.: US 2009/0202770 A1
(43) Pub. Date: Aug. 13, 2009

(54) Polypropylene/polyisobutylene blends and films prepared from same

(76) Inventors: Fengkui Li, Houston, TX (US); Luyi Sun, Pearland, TX (US)

Correspondence Address: David J. Alexander;Fina Technology, Inc., P.O. Box 674412, Houston, TX, 77267-4412, US

(21) Appl. No.: 12/028,535

(22) Filed: Feb. 8, 2008

(51) Int. Cl. C08L 23/12; B29D 22/00

(52) U.S. Cl. 428/36.92; 525/240

(57) ABSTRACT

A film prepared from a polypropylene and polyisobutylene blend wherein the film has a stretching force that is reduced by about 5% to 200% when compared to an otherwise similar film prepared in the absence of polyisobutylene. A method of producing film comprising contacting polypropylene and polyisobutylene to form a polymeric blend, forming the polymeric blend into a film, and orienting the film.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

This disclosure relates to polymeric blends having improved manufacturing characteristics. More specifically, this disclosure relates to blends of polypropylene and polyisobutylene and films prepared from same.

2. Background

Synthetic polymeric materials, particularly polypropylene resins, are widely used in the manufacturing of a variety of end-use articles ranging from medical devices to food containers. Many industries, such as the packaging industry, utilize these polypropylene materials in various manufacturing processes to create a variety of finished goods.

Within the packaging industry, there are a number of unique applications that ideally require flexible polymers. Manufacturers continue to develop polymer formulations that can be stretched more easily, which could translate into improved manufacturing efficiency as a result of factors such as decreased energy consumption and increased line speed. Given the foregoing discussion, it would be desirable to develop polymeric compositions that retain user-desired mechanical and/or physical properties while having an increased flexibility and ease of processing.

### SUMMARY

Disclosed herein is a film prepared from a polypropylene and polyisobutylene blend wherein the film has a stretching force that is reduced by about 5% to 200% when compared to an otherwise similar film prepared in the absence of polyisobutylene.

Also disclosed herein is a method of producing film comprising contacting polypropylene and polyisobutylene to form a polymeric blend, forming the polymeric blend into a film, and orienting the film.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of yield stress in the machine direction as a function of oven temperature for the samples from Example 1.

FIG. 2 is a plot of stretching force in the machine direction as a function of time at a temperature of 140° C. for the samples from Example 1.

FIG. 3 is a plot of stretching force in the machine direction as a function of time at a temperature of 160° C. for the samples from Example 1.

FIG. 4 is a plot of gloss 45° as a function of temperature at which the samples from Example 1 were made.

FIG. 5 is a plot of haze percentage as a function of temperature at which the samples from Example 1 were made.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are methods of preparing a polymeric blend comprising polypropylene and polyisobutylene. Hereinafter, it will be referred to as the PP/PIB blend. The PP/PIB blend may be used to produce biaxially oriented polypropylene (BOPP) films by processes to be described in detail later herein.

In an embodiment, the polymeric blend comprises a polypropylene homopolymer, alternatively a high crystallinity polypropylene homopolymer. The polypropylene homopolymer may be present in the PP/PIB blend in an amount of from 60 wt. % to 99 wt. % by total weight of the PP/PIB blend, alternatively from 80 wt. % to 98 wt. %, alternatively from 85 wt. % to 97 wt. %.

In an embodiment, the polypropylene is a homopolymer provided however that the homopolymer may contain up to about 5% of another alpha-olefin, including but not limited to C₂-C₈ alpha-olefins such as ethylene and 1-butene. Despite the potential presence of small amounts of other alpha-olefins, the polypropylene is generally referred to as a polypropylene homopolymer. Polypropylene homopolymers suitable for this disclosure may include any type of polypropylene known in the art. For example, the polypropylene homopolymer may be atactic polypropylene, isotactic polypropylene, hemi-isotactic, syndiotactic polypropylene, or combinations thereof. A polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain. In hemi-isotactic polymer, every other repeat unit has a random substituent.

In an embodiment, a polypropylene suitable for use in this disclosure may generally have a density, determined by ASTM D1505, of from 0.895 g/cc to 0.920 g/cc or from 0.900 g/cc to 0.915 g/cc or from 0.905 g/cc to 0.915 g/cc. In an embodiment, a polypropylene suitable for use in this disclosure may generally have a melt-mass flow rate, determined by ASTM D1238, of from 0.5 g/10 min. to 15.0 g/10 min. or from 1.0 g/10 min. to 5.0 g/10 min. or from 1.0 g/10 min. to 3.0 g/10 min. In an embodiment, a polypropylene suitable for use in this disclosure may generally have a tensile modulus, determined by ASTM D638, of from 200,000 psi to 320,000 psi, or from 220,000 psi to 320,000 psi, or from 250,000 psi to 320,000 psi. In an embodiment, a polypropylene suitable for use in this disclosure may generally have a flexural modulus, determined by ASTM D790, of from 170,000 psi to 300,000 psi, or from 190,000 psi to 300,000 psi, or from 220,000 psi to 300,000 psi. In an embodiment, a polypropylene suitable for use in this disclosure may generally have a melting temperature, determined by differential scanning calorimetry (DSC), of from 150° C. to 170° C., or from 155° C. to 170° C., or from 160° C. to 170° C.

An example of a polypropylene suitable for use in this disclosure includes without limitation Total Petrochemicals 3365, which is a polypropylene homopolymer commercially available from Total Petrochemicals USA, Inc. The polypropylene homopolymer (e.g., Total Petrochemicals 3365) may generally have the physical properties set forth in Table 1.

TABLE 1

| | |
|---|---|
| 3365 | |
| Typical Value | Test Method |

Physical Properties

| | | |
|---|---|---|
| Density, g/cc | 0.905 | ASTM D1505 |
| Melt Mass-Flow Rate | 3.8 | ASTM D1238 |
| (MFR), g/10 min. | | |
| Mechanical Properties | | |
| Tensile Modulus, psi | 220,000 | ASTM D638 |
| Flexural Modulus, psi | 200,000 | ASTM D790 |
| Thermal Properties⁽¹⁾ | | |
| Melting Temperature, ° F. | 330 | DSC |

In another embodiment, the polypropylene may be a high crystallinity polypropylene homopolymer (HCPP). The HCPP may contain primarily isotactic polypropylene. The isotacticity in polymers may be measured via ¹³C NMR spectroscopy using meso pentads and can be expressed as percentage of meso pentads (% mmmm). As used herein, the term “meso pentads” refers to successive methyl groups located on the same side of the polymer chain. In an embodiment, the HCPP has a meso pentads percentage of greater than 97%, or greater than 98%, or greater than 99%.

The HCPP may comprise some amount of atactic or amorphous polymer. The atactic portion of the polymer is soluble in xylene, and is thus termed the xylene soluble fraction (XS %). In determining XS %, the polymer is dissolved in boiling xylene and then the solution cooled to 0° C. that results in the precipitation of the isotactic or crystalline portion of the polymer. The XS % is that portion of the original amount that remained soluble in the cold xylene. Consequently, the XS % in the polymer is indicative of the extent of crystalline polymer formed. The total amount of polymer (100%) is the sum of the xylene soluble fraction and the xylene insoluble fraction. Methods for determination of the XS % are known in the art, for example the XS % may be determined in accordance with ASTM D5492-98. In an embodiment, the HCPP has a xylene soluble fraction of less than 1.5%, or less than 1.0%, or less than 0.5%.

In an embodiment, a HCPP suitable for use in this disclosure may generally have a density, determined by ASTM D1505, of from 0.895 g/cc to 0.920 g/cc, or from 0.900 g/cc to 0.915 g/cc, or from 0.905 g/cc to 0.915 g/cc. In an embodiment, a HCPP suitable for use in this disclosure may generally have a melt-mass flow rate, determined by ASTM D1238, of from 0.5 g/10 min. to 15.0 g/10 min. or from 1.0 g/10 min. to 5.0 g/10 min. or from 1.0 g/10 min. to 3.0 g/10 min. In an embodiment, a HCPP suitable for use in this disclosure may generally have a secant modulus in the machine direction (MD), determined by ASTM 882, of from 350,000 psi to 420,000 psi, or from 380,000 psi to 420,0000 psi, or from 400,000 psi to 420,000 psi. In an embodiment, a HCPP suitable for use in this disclosure may generally have a secant modulus in the transverse direction (TD), determined by ASTM 882, of from 600,000 psi to 700,000 psi, or from 620,000 psi to 700,0000 psi, or from 650,000 psi to 700,000 psi. In an embodiment, a HCPP suitable for use in this disclosure may generally have a tensile strength at beak in the MD, determined by ASTM 882, of from 19,000 psi to 28,000 psi, or from 22,000 psi to 28,000 psi, or from 25,000 psi to 28,000 psi. In an embodiment, a HCPP suitable for use in this disclosure may generally have a tensile strength at beak in the TD, determined by ASTM 882, of from 33,000 psi to 39,000 psi, or from 35,000 psi to 39,000 psi, or from 37,000 psi to 39,000 psi. In an embodiment, a HCPP suitable for use in this disclosure may generally have an elongation at break in the MD, determined by ASTM 882, of from 125% to 155%, or from 130% to 150%, or from 135% to 145%. In an embodiment, a HCPP suitable for use in this disclosure may generally have an elongation at break in the TD, determined by ASTM 882, of from 45% to 65%, or from 50% to 60%, or from 50% to 55%. In an embodiment, a HCPP suitable for use in this disclosure may generally have a melting temperature, determined by DSC, of from 160° C. to 170° C., or from 162° C. to 170° C., or from 165° C. to 170° C. In an embodiment, a HCPP suitable for use in this disclosure may generally have gloss (45°), determined by ASTM D2457, of from 80 to 90, or from 85 to 90, or from 88 to 90. In an embodiment, a HCPP suitable for use in this disclosure may generally have a haze, determined by ASTM D1003, of from 0.5% to 1.5%, or from 1.0% to 1.5%, or from 1.0% to 1.2%. In an embodiment, a HCPP suitable for use in this disclosure may generally have a water vapor transmission rate (100° F., 90% R.H g-mil/100 in²/day), determined by ASTM F1249-90, of from 0.200 to 0.300, or from 0.200 to 0.250, or from 0.200 to 0.205.

An example of an HCPP suitable for use in this disclosure includes without limitation Total Petrochemicals 3270, which is an HCPP commercially available from Total Petrochemicals USA, Inc. The HCPP (e.g. Total Petrochemicals 3270) may generally have the physical properties set forth in Table 2.

TABLE 2

| | |
|---|---|
| 3270 | |
| Typical Value | Test Method |

Physical Properties

| | | |
|---|---|---|
| Density, g/cc | 0.910 | ASTM D1505 |
| Melt Mass-Flow Rate (MFR) | 2.0 | ASTM D1238 |
| (230° C./2.16 kg), g/10 min. | | |
| BOPP Mechanical Properties | | |
| Secant Modulus MD, psi | 420,000 | ASTM 882 |
| Secant Modulus TD, psi | 700,000 | ASTM 882 |
| Tensile Strength at Break MD, psi | 28,000 | ASTM 882 |
| Tensile Strength at Break TD, psi | 39,000 | ASTM 882 |
| Elongation at Break MD, % | 150 | ASTM 882 |
| Elongation at Break TD, % | 60 | ASTM 882 |
| Thermal Properties | | |
| Melting Temperature, ° F. | 329 | DSC |
| Optical Properties | | |
| Gloss (45°) | 85 | ASTM D2457 |
| Haze, % | 1.0 | ASTM D1003 |
| Additional Properties | | |
| Water Vapor Transmission, 100° F., | 0.2 | ASTM |
| 90% R.H, g-mil/100 in²/day | | F1249-90 |

In an embodiment, the polypropylene may also contain additives to impart desired physical properties, such as printability, increased gloss or a reduced blocking tendency. Examples of additives include without limitation stabilizers, ultra-violet screening agents, oxidants, anti-oxidants, anti-static agents, ultraviolet light absorbents, fire retardants, processing oils, mold release agents, coloring agents, pigments/dyes, fillers, and/or other additives known to one skilled in the art. The aforementioned additives may be used either singularly or in combination to form various formulations of the polymer. For example, stabilizers or stabilization agents may be employed to help protect the polymer resin from degradation due to exposure to excessive temperatures and/or ultraviolet light. Optionally, these additives, which may be added to the PP, the PIB or the PP/PIB blend, may be included in amounts effective to impart the desired properties. Effective additive amounts and processes for inclusion of these additives to polymeric compositions would be apparent to one skilled in the art with the aid of the present disclosure. For example, the total amount of additives present in the composition may range from 200 parts per million (ppm) to 20000 ppm, alternatively from 500 ppm to 10000 ppm, and alternatively from 500 ppm to 5000 ppm.

Polypropylene may be prepared using any suitable methods known to one or ordinary skill in the art. For example, the polypropylene may be prepared using a Ziegler-Natta catalyst, metallocene catalyst, or combinations thereof.

The polypropylene may be prepared using Ziegler-Natta catalysts, which are typically based on titanium and organometallic aluminum compounds, for example triethylaluminum (C₂H₅)₃Al. Ziegler-Natta catalysts and processes for forming such catalysts are known in the art and examples of such are described in U.S. Pat. Nos. 4,298,718, 4,544,717, and 4,767,735, each of which is incorporated by reference herein.

Alternatively, the polypropylene may be prepared using a metallocene catalyst. Metallocene catalysts may be characterized generally as coordination compounds incorporating one or more cyclopentadienyl (Cp) groups (which may be substituted or unsubstituted, each substitution being the same or different) coordinated with a transition metal through π bonding. Examples of metallocene catalysts and processes for forming such catalysts are described in U.S. Pat. Nos. 4,794,096 and 4,975,403, each of which is incorporated by reference herein. Examples of polypropylene prepared through the use of metallocene catalysts are described in further detail in U.S. Pat. Nos. 5,158,920, 5,416,228, 5,789,502, 5,807,800, 5,968,864, 6,225,251, 6,777,366, 6,777,367, 6,579,962, 6,468,936, 6,579,962 and 6,432,860, each of which is incorporated by reference herein.

Polypropylene may also be prepared using any other method such as a combination of Ziegler-Natta and metallocene catalysts, for example as described in U.S. Pat. Nos. 7,056,991 and 6,653,254, each of which is incorporated by reference herein.

The polypropylene may be formed by placing propylene alone in a suitable reaction vessel in the presence of a catalyst (e.g., Ziegler-Natta, metallocene, etc) and under suitable reaction conditions for polymerization thereof. Standard equipment and processes for polymerizing the propylene into a polymer are known to one skilled in the art. Such processes may include solution phase, gas phase, slurry phase, bulk phase, high pressure processes or combinations thereof. Such processes are described in detail in U.S. Pat. Nos. 5,525,678, 6,420,580, 6,380,328, 6,359,072, 6,346,586, 6,340,730, 6,339,134, 6,300,436, 6,274,684, 6,271,323, 6,248,845, 6,245,868, 6,245,705, 6,242,545, 6,211,105, 6,207,606, 6,180,735 and 6,147,173, which are incorporated herein by reference in their entirety.

In an embodiment, the polypropylene is formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig, or from 250 psig to 350 psig. The reactor temperature in a gas phase process may vary from 30° C. to 120° C., or from 60° C. to 115° C., or from 70° C. to 110° C., or from 70° C. to 95° C., for example U.S. Pat. Nos. 4,543,399, 4,588,790, 5,028,670, 5,317,036, 5,352,749, 5,405,922, 5,436,304, 5,456,471, 5,462,999, 5,616,661, 5,627,242, 5,665,818, 5,677,375 and 5,668,228, which are incorporated herein by reference in their entirety.

In an embodiment, the polypropylene is formed by a slurry phase polymerization process. Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene). The medium employed is generally liquid under the conditions of polymerization and relatively inert. A bulk phase process is similar to that of a slurry process. However, a process may be a bulk process, a slurry process or a bulk slurry process.

In an embodiment, the PP/PIB blend comprises polyisobutylene. Polyisobutylene is a polymer of a C₄ hydrocarbon, which is also known as butyl rubber, or synthetic rubber and is a colorless to slightly yellow viscous liquid. Polyisobutylene may be prepared using any suitable method known to one of ordinary skill in the art. For example, polyisobutylene may be prepared by polymerization of isobutylene with isoprene. The polymerization may be a radical polymerization, cationic addition polymerization, or anionic addition polymerization. Any suitable catalyst and/or co-catalyst may be used in the polymerization, such as boron trifluoride complex, titanium tetrachloride, titanium tetrabromide, vanadium tetrachloride. Additives and initiators (e.g., hydrofluoric acid, etc) may be used and are known to one skilled in the art. Examples of processes to produce polyisobutylene are described in U.S. Pat. Nos. 7,217,773 B2, 6,642,329 B1, 6,252,021 B1, 5,910,550, and 5,191,044, which are incorporated herein by reference in their entirety.

Polyisobutylene suitable for use in this disclosure may comprise a mixture of polymers differing in molecular weight. In an embodiment, the polyisobutylene may have a number average molecular weight (Mₙ) of from 500 Daltons to 50,000 Daltons, or from 800 Daltons to 10,000 Daltons, or from 800 Daltons to 5,000 Daltons. Polyisobutylene may be further characterized by the width of the molecular weight distribution, also termed the polydispersity index (PDI), which is calculated by dividing the weight average molecular weight by the number average molecular weight (Mw/Mn). In an embodiment, polyisobutylene suitable for use in this disclosure may have a PDI of from 1.1 to 5.0, or from 1.1 to 3.0, or from 1.1 to 2.0.

In an embodiment, a polyiosbutylene suitable for use in this disclosure has a viscosity at 100° C., determined by ASTM D445, of from 100 cSt to 1,000 cSt, or from 150 cSt to 500 cSt, or from 200 cSt to 235 cSt. In an embodiment, a polyiosbutylene suitable for use in this disclosure has a specific gravity at 15.5° C., determined by ASTM D1298, of from 0.890 to 0.895, or from 0.891 to 0.894, or from 0.892 to 0.893. In an embodiment, a polyiosbutylene suitable for use in this disclosure has a refractive index, determined by ASTM D1218, of from 1.493 to 1.495, or from 1.494 to 1.495. In an embodiment, a polyiosbutylene suitable for use in this disclosure has a glass transition temperature of from −68 to −70° C., or from −69 to −70° C., or from −69.5 to −69.8° C.

An example of a polyisobutylene suitable for use in this disclosure includes without limitation INDOPOL H-100, which is a polyisobutylene commercially available from British Petroleum. Polyisobutylene (e.g. INDOPOL H-100) may generally have the physical properties set forth in Table 3.

TABLE 3

| Properties | Typical Value | Test Method |
|---|---|---|
| Viscosity at 100° C., cSt | 200-235 | ASTM D445 |
| Specific Gravity at 15.5° C. | 0.893 | ASTM D1298 |
| Refractive Index | 1.494 | ASTM D1218 |
| Molecular Weight, Mn | 910 | modified ASTM D3536 |
| Polydispersity Index, Mw/Mn | 1.60 | modified ASTM D3536 |
| Glass Transition Temperature | −69.6 | n/a |

In an embodiment, polyisobutylene is present in the PP/PIB blend in an amount of from 1 wt. % to 40 wt. % by total weight of the PP/PIB blend, or from 1 wt. % to 30 wt. %, or from 1 wt. % to 20 wt. %, or from 1 wt. % to 15 wt. %, or from 1 wt. % to 10 wt. %, or from 1 wt. % to 5 wt. %.

In an embodiment, the PP/PIB blend is used to form an article wherein the article is a film, alternatively a biaxially oriented film. Generally, orientation of a polymer composition refers to the process whereby directionality (the orientation of molecules relative to each other) is imposed upon the polymeric arrangements in the film. Such orientation is employed to impart desirable properties to films, such as toughness and opaqueness, for example. As used herein, the term “biaxial orientation” refers to a process in which a polymeric composition is heated to a temperature at or above its glass-transition temperature but below its crystalline melting point. Immediately following heating, the material may then be extruded into a film, and stretched in both a longitudinal direction (i.e., the machine direction) and in a transverse or lateral direction (i.e., the tenter direction).

In an embodiment, a PP/PIB blend of the type described herein is heated in an extruder to a temperature of equal to or less than 260° C., or from 180° C. to 250° C., or from 200° C. to 230° C. The molten polymer may then exit through a die and the molten plaque may be used to form an extruded film, a cast film, a biaxially oriented film, or the like. In an embodiment, the molten plaque may exit through the die and be taken up onto a roller without additional stretching to form an extruded film. Alternatively, the molten plaque may exit through the die and be uniaxially stretched while being taken up onto a chill roller where it is cooled to produce a cast film.

In an embodiment, the molten plaque exits through the die and is passed over a first roller (e.g., a chill roller) which solidifies the polymeric composition (i.e., PP/PIB blend) into a film. Then, the film may be oriented by stretching such film in a longitudinal direction and in a transverse direction. The longitudinal orientation is generally accomplished through the use of two sequentially disposed rollers, the second (or fast roller) operating at a speed in relation to the slower roller corresponding to the desired orientation ratio. Longitudinal orientation may alternatively be accomplished through a series of rollers with increasing speeds, sometimes with additional intermediate rollers for temperature control and other functions.

After longitudinal orientation, the film may be cooled, pre-heated and passed into a lateral orientation section. The lateral orientation section may include, for example, a tenter frame mechanism, where the film is stressed in the transverse direction. Annealing and/or additional processing may follow such orientation.

In an alternative embodiment, the film may be stressed in both directions at the same time. In an embodiment, the film may be produced using a stretching force of from 0.1 MPa to 50 MPa, alternatively from 0.1 MPa to 20 MPa, alternatively from 0.1 MPa to 10 MPa. In an embodiment, the film is oriented in the machine direction at a temperature of from 90° C. to 180° C., alternatively from 110° C. to 170° C. and alternatively from 130° C. to 170° C. and is oriented in the transverse direction at a temperature of from 90° C. to 180° C., alternatively from 110° C. to 170° C., and alternatively from 130° C. to 170° C.

Without wishing to be limited by theory, on cooling, the molecular alignment imposed by stretching competes favorably with crystallization, and the drawn polymer molecules condense into a crystalline network with crystalline domains aligned in the direction of the stretching force. Additional disclosure on biaxial film production may be found in U.S. Pat. No. 4,029,876 and U.S. Pat. No. 2,178,104, each of which is incorporated by reference herein in its entirety.

The PP/PIB blends of this disclosure may require a lower stretching force in the machine direction (MD) and/or traverse direction (TD) to form articles (e.g., films) when compared to articles prepared from an otherwise similar composition lacking polyisobutylene. In an embodiment, the stretching force of articles prepared from the PP/PIB blends of this disclosure is lowered by from 5% to 200%, alternatively from 5% to 100%, alternatively from 5% to 20% when compared to articles (e.g., films) prepared from an otherwise similar composition lacking polyisobutylene. In another embodiment, the stretching force of the articles prepared from the PP/PIB blends of this disclosure ranges from 0.2 MPa to 10 MPa, or from 0.2 MPa to 5 MPa, or from 0.2 MPa to 2.0 MPs.

Articles formed from the PP/PIB may also display an improved shrinkage as determined by a decrease in shrinkage in the MD and/or the TD when compared to articles prepared from an otherwise similar composition lacking polyisobutylene. Shrinkage may be calculated by first measuring the length of contraction upon cooling in the in-flow direction (termed MD when measuring differential shrinkage) and the length of contraction occurring in the cross-flow direction (termed TD when measuring differential shrinkage). The difference in the in-flow and cross-flow contractions multiplied by 100% gives the percent shrinkage. In an embodiment, the shrinkage of an article prepared from the PP/PIB blend at 125° C. is reduced by from 10% to 100%, alternatively from 20% to 50%, alternatively from 25% to 30% when compared to articles (e.g., films) prepared from an otherwise similar composition lacking polyisobutylene. In another embodiment, the shrinkage of the article prepared from a PP/PIB blend of the type described herein at 125° C. ranges from 0.5% to 5%, or from 1% to 3%, or from 1.5% to 3% based on the original size of the article.

Articles prepared from the PP/PIB blend may also display improved tensile properties, such as tensile strength at break (also termed yield/break strength) and tensile elongation (also termed elongation at yield/break), when compared to articles (e.g., films) prepared from an otherwise similar composition lacking polyisobutylene. The tensile strength at break is the force per unit area required to break a material. In an embodiment, an article (e.g., film) prepared from a PP/PIB blend of this disclosure has a tensile strength at break that ranges from 10 kpsi to 40 kpsi, or from 20 kpsi to 30 kpsi, or from 25 kpsi to 30 kpsi, as determined in accordance with ASTM D882. The tensile elongation is the percentage increase in length that occurs before a material breaks under tension. In an embodiment, an article (e.g., film) prepared from a PP/PIB blend of this disclosure has a tensile elongation at break that ranges from 10% to 200%, or from 50% to 150%, or from 70% to 100%, as determined in accordance with ASTM D882.

In an embodiment, articles (e.g., films) produced from the PP/PIB blends of this disclosure comprising from 1 wt. % to 10 wt. % PIB based on the total weight of the composition may display higher permeability when compared to articles (e.g., films) prepared from an otherwise similar composition lacking polyisobutylene. For example, films prepared from PP/PIB blends comprising from 1 wt. % to 10 wt. % PIB based on the total weight of the composition may have an increased oxygen transmission rate (OTR). In an embodiment, articles (e.g., films) produced from the PP/PIB blends comprising greater than 10 wt. % PIB based on the total weight of the composition may display lower permeability (increased barrier properties) when compared to articles (e.g., films) prepared from an otherwise similar composition lacking polyisobutylene. For example, films prepared from PP/PIB blends comprising greater than 10 wt. % PIB may have a decreased oxygen transmission rate.

OTR is the steady state rate at which oxygen gas permeates through a film at specified conditions of temperature and relative humidity. OTR may be measured by exposing one side of a film to an oxygen atmosphere. As the oxygen solubilizes into the film and permeates through the material, nitrogen sweeps the opposite side of the film and transports the transmitted oxygen molecules to a coulometric sensor. This value is reported as a transmission rate. When this rate is multiplied by the average thickness of the material, the results are considered a permeability rate. In an embodiment, the films produced from PP/PIB blends of this disclosure comprising from 1 wt. % to 10 wt. % PIB based on the total weight of the composition have oxygen transmission rates of from 20 to 200 cc/100 in²/24 h at 100° F., or from 100 to 180 cc/100 in²/24 h at 100° F., or from 130 to 180 cc/100 in²/24 h at 100° F., as determined in accordance with ASTM D3895.

Additionally, the articles (e.g., films) of this disclosure prepared from PP/PIB blends comprising from 1 wt. % to 10 wt. % PIB based on the total weight of the composition may have an increased water vapor transmission rate (WVTR) when compared to articles (e.g., films) prepared from an otherwise similar composition lacking polyisobutylene. Alternatively, articles (e.g., films) of this disclosure prepared from PP/PIB blends comprising greater than 10 wt. % PIB based on the total weight of the composition may have a decreased water vapor transmission rate (WVTR) when compared to articles (e.g., films) prepared from an otherwise similar composition lacking polyisobutylene. WVTR is the steady state rate at which water vapor permeates through a film at specified conditions of temperature and relative humidity. WVTR may be measured by exposing one side of a film to a dry stream (with low water vapor pressure), and the other side to a wet stream. The partial pressure difference between the two sides of the film creates a driving force for the water vapor to permeate through the film to go from the wet to the dry side. Similar to OTR, the water vapor on the dry side is detected using a sensor and the value is reported as a transmission rate. In an embodiment, the articles (e.g. films) prepared from a PP/PIB blend comprising from 1 wt. % to 10 wt. % PIB based on the total weight of the composition may have a water vapor transmission rate of from 0.1 to 1.0 g/100 in²/24 hrs at 100° F. and 100% relative humidity, or from 0.2 to 0.7 g/100 in²/24 hrs at 100° F. and 100% relative humidity, or from 0.2 to 0.6 g/100 in²/24 hrs at 100° F. and 100% relative humidity, as determined in accordance with ASTM F1249.

The articles (e.g., films) of this disclosure may also display comparable optical properties when compared to articles (e.g., films) prepared from an otherwise similar composition lacking polyisobutylene. Haze indicates the degree to which an article (e.g., film) has reduced clarity or cloudiness while gloss is a measurement of the relative luster or shininess of a film surface. In an embodiment, the articles (e.g., films) of this disclosure have a haze percentage of from 0.1% to 5%, alternatively from 0.2% to 2%, alternatively from 0.2% to 0.5% when stretched at a temperature ranging from 130° C. to 155° C., as determined in accordance with ASTM D1003 and a gloss at 45° of from 60% to 100%, alternatively from 70% to 90%, alternatively from 80% to 90% when stretched at a temperature ranging from 130° C. to 155° C., as determined in accordance with ASTM D523.

In an embodiment, the color of the articles (e.g., films) produced with the PP/PIB blends of this disclosure may be comparable to that of articles (e.g., films) prepared from an otherwise similar composition lacking polyisobutylene. In general, BOPP films for example tend to have a slight yellow color. The yellowness may be measured in terms of its Yellowness Index, as determined in accordance with ASTM D1925. In an embodiment, the articles (e.g., films) of this disclosure have yellowness index of from −2 to 10, or from 1 to 5, or from 0 to 1.

The PP/PIB blends of this disclosure may be converted to end-use articles by any suitable method. In an embodiment, this conversion is a plastics shaping process such as known to one of ordinary skill in the art. Examples of end use articles into which the polymeric blend may be formed include food packaging, office supplies, plastic lumber, replacement lumber, patio decking, structural supports, laminate flooring compositions, polymeric foam substrate; decorative surfaces (i.e., crown molding, etc) weatherable outdoor materials, point-of-purchase signs and displays, house wares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth. Additional end use articles would be apparent to those skilled in the art.

Films produced from the PP/PIB blends of this disclosure may require a lower stretching force that could be translated to lower energy consumption and faster line speed. The articles (e.g., films) of this disclosure may also display improved shrinkage while maintaining other properties (e.g., haze) at values comparable to that of films produced from an otherwise similar composition lacking polyisobutylene.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims to follow in any manner.

### Example 1

The melt flow rate and flexibility of films prepared from either a PP homopolymer or a PP/PIB blend were investigated and compared. A polypropylene sample (Sample 1) was prepared using Total Petrochemicals 3365 which is a polypropylene homopolymer commercially available from Total Petrochemicals USA, Inc. A PP/PIB blend (Sample 2) was prepared by incorporating 2.4 wt. % of INDOPOL H-100 (i.e., PIB) into 3365. The PP/PIB blend was extruded and cast into 16 mil sheets followed by stretching using a Brückner stretcher (Laboratory stretcher manufactured by Brückner, Siegsdorf, Germany). Sample 1 was re-extruded under the same conditions as Sample 2. Sheets produced using Samples 1 and 2 were stretched biaxially at 140, 145, 150, 155, 160° C. to a 6×6 areal draw ratio at both MD and TD speeds of 30 m/min, a preheating time of 30 seconds, and a clip temperature of 100° C.

The melt flow rate was determined for both samples. The melt flow rate for 3365 was 3.7 g/10 min. The presence of 2.4 wt % PIB diluted the 3365 melt and increased the melt flow rate for the PP/PIB blend from 3.7 to 4.7 g/10 min. The PP/PIB blend also had a slightly lower recrystallization temperature and degree of crystallinity when compared to 3365 (Sample 1). Finally, the reextrusion process of Sample 1 increased its color from 0.5 to 4.7 (color b), extrusion of 3365/PIB blend (Sample 2) resulted in similar color to the re-extruded base resin. The results are also tabulated in Table 4.

TABLE 4

| | PP | PP/PIB |
|---|---|---|
| Properties | Sample 1 | Sample 2 |
| Melt Flow Rate (g/10 minutes) | 3.7 | 4.7 |
| DSC - recrystallization temperature (° C.) | 120.1 | 118.8 |
| DSC - heat of recrystallization | −96.2 | −91.5 |
| DSC - melting point (° C.) | 164.0 | 162.5 |
| DSC - heat of fusion (J/g) | 96.6 | 92.0 |
| Resin Color a | −2.20 | −2.03 |
| Resin Color b | 4.69 | 4.71 |
| Resin Color L | 71.5 | 71.6 |
| Resin YI | 9.52 | 9.72 |

### Example 2

The flexibility of both of the samples in Example 1 was further investigated. Both sheets from Example 1 were stretched with a starting temperature of 135° C. Both sheets failed to stretch at 135° C. Without wishing to be limited by theory, the samples may have failed to stretch because they might need longer time for heat transfer or higher temperature.

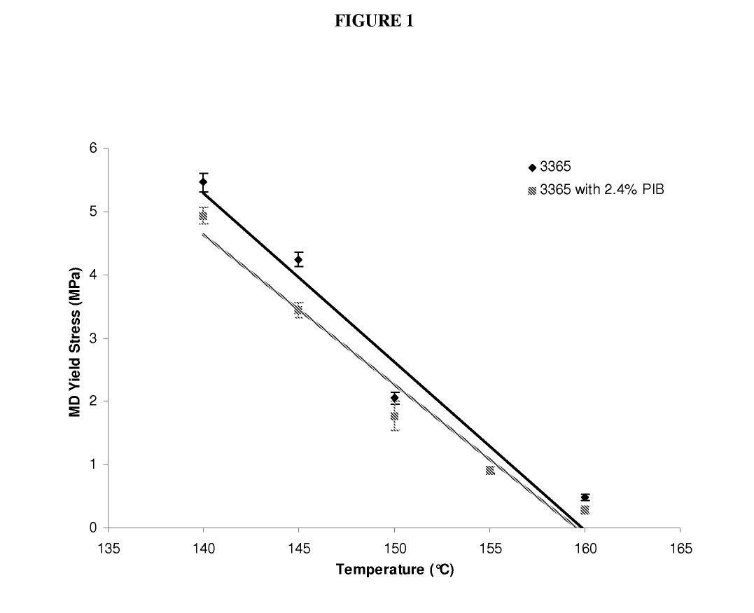

The Brückner stretch experiment was repeated for both sheets. They were successfully stretched from 140° C. up to 160° C., and failed to stretch at 165° C. This experiment showed that the addition of 2.4 wt. % PIB does not narrow or change the processing window of 3365. The drawing stresses were also investigated where yield stresses for both samples were plotted as a function of temperature in FIG. 1. Referring to FIG. 1, the incorporation of PIB into 3365 lowered its yield stress and this trend was more clearly observed at lower temperatures. For example, at 140° C., the addition of 2.4 wt. % PIB lowered the stretching force by 10%.

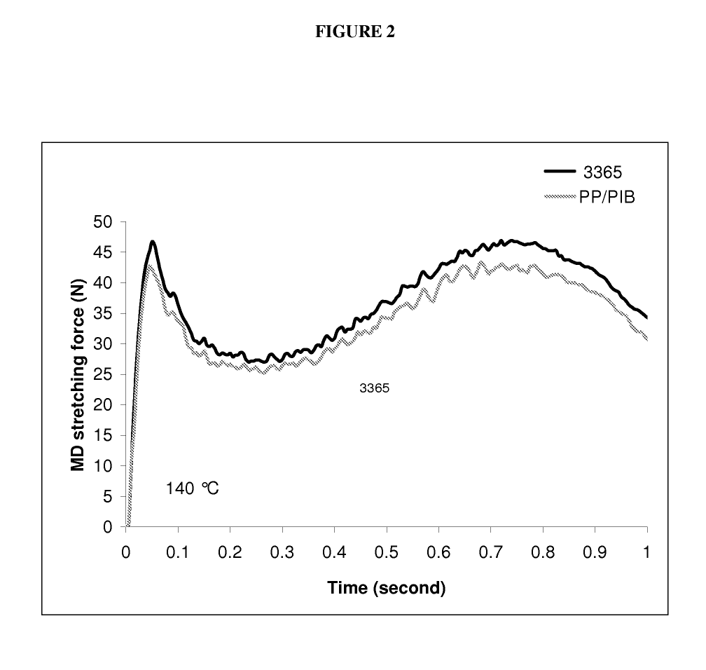

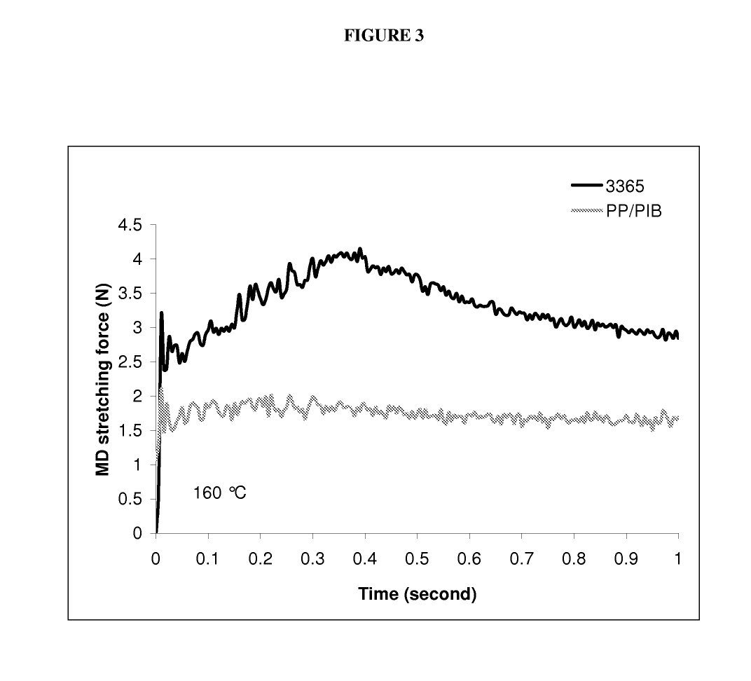

The stretching force was also plotted as a function of time in the machine direction at 140° C. and 160° C. in FIGS. 2 and 3. Since the film was stretched at a constant rate of 30 m/min simultaneously in the machine and transverse directions, the stretching time axis could be translated into strain. Referring to FIG. 2, an intrinsic yield point (defined as the maximum point followed by strain softening) was observed at 140° C. for both samples. The PP/PIB blend was shown to require a lower stretch force to yield compared to 3365. After strain softening, the stretching stress increased with time (strain), i.e. strain hardening, due to significant polymer chain orientation at large strains. In general, both samples showed a similar stretching trend.

At a higher temperature of 160° C., the samples were easier to stretch thus the yield stress was lower. Referring to FIG. 3, there is no clear intrinsic yield point for either sample. The stretching stress for Sample 1 (i.e., 3365) increased over time which may be attributable to chain orientation. In contrast, the stretching stress for Sample 2 (i.e., the PP/PIB blend) was maintained at a relatively steady level. This steady stretching stress trend indicated that Sample 2 did not achieve sufficient stretch orientation at 160° C. Without wishing to be limited by theory, the PIB might act as a plasticizer in the PP/PIB blend and weaken the friction force between polypropylene chains, especially at higher temperatures. When the PP/PIB blend was stretched at 160° C., due to the plasticization from PIB, the chains may slip with each other rather than be oriented.

### Example 3

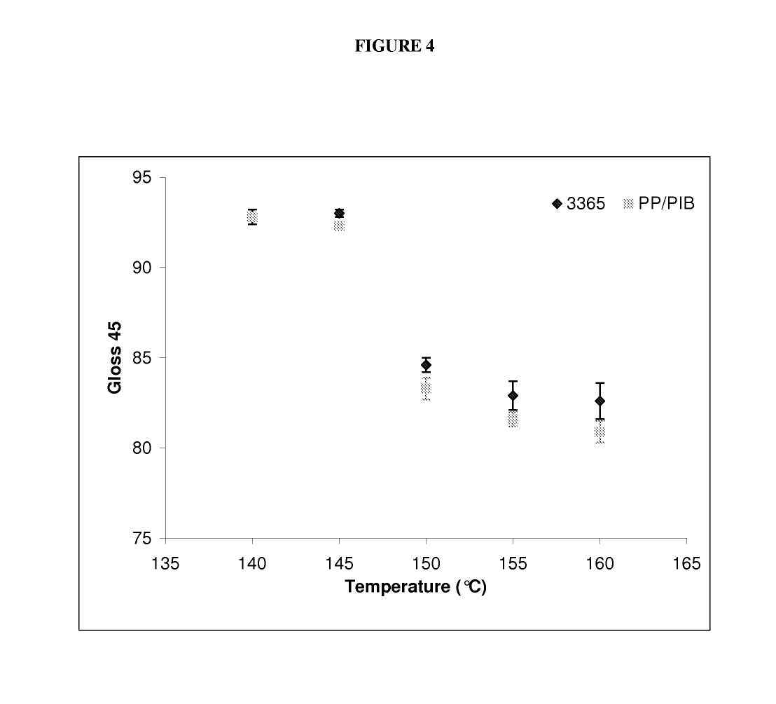

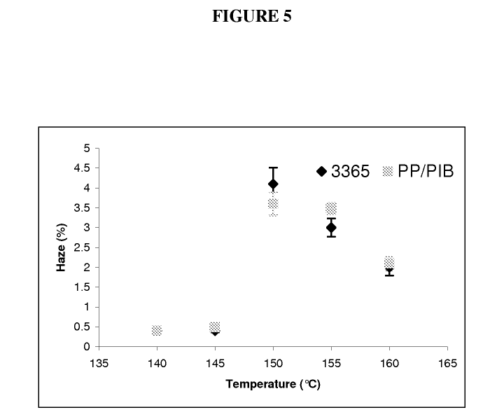

The gloss 45° and haze percentage were investigated for the samples from Example 1. FIG. 4 is a plot of gloss 45° as a function of the temperature at which the film samples were made. As shown, the addition of 2.4 wt. % PIB exerted a relatively small effect on the gloss 45°. FIG. 5 is a plot of haze percentage as a function of temperatures. Referring to FIG. 5, the haze percentages for both samples were 0.5% at 140 and 145° C., increased to 4% at 150° C., and then decreased at 155 and 160° C. The results demonstrate that the PP/PIB blend films exhibited comparable optical properties to those of the neat polypropylene films.

### Example 4

The effect of PIB on the color of the samples was investigated using a Hunter colorimeter. The Hunter colorimeter uses an opponent-color scale that proved measurements of color in units of approximate visual uniformity. Thus in the Hunter scale, L measures lightness and varies from 100 for perfect white to zero for black, approximately as the eye would evaluate it. The chromacity dimensions (a and b) give understandable designations of color as follows:

a measures redness when positive, gray when zero and greenness when negative

b measures yellowness when positive, gray when zero, and blueness when negative

Additionally, the Hunter colorimeter measures the yellowness index or YI. Visually, yellowness is associated with scorching, soiling and general product degradation by light, chemical exposure, and processing. Yellowness indices are used chiefly to measure these types of degradation. The yellowness index is calculated by the Hunter colorimeter per ASTM Method E 313. The colors of both the 3365 and PP/PIB blend from Example 1 at different temperatures were determined and are listed in Table 5.

TABLE 5

| | | Stretch | | | | | |
|---|---|---|---|---|---|---|---|
| | | Temperature | | | | | |
| Sample | Films | (° C.) | 140 | 145 | 150 | 155 | 160 |
| 1 | 3365 | Color L | 87.9 | 88.0 | 88.1 | 88.2 | 88.2 |
| 2 | PP/PIB | | 88.0 | 88.0 | 88.2 | 88.2 | 88.1 |
| 1 | 3365 | Color a | −0.92 | −0.90 | −0.84 | −0.86 | −0.84 |
| 2 | PP/PIB | | −0.87 | −0.87 | −0.85 | −0.86 | −0.81 |
| 1 | 3365 | Color b | 0.60 | 0.52 | 0.40 | 0.32 | 0.33 |
| 2 | PP/PIB | | 0.53 | 0.47 | 0.39 | 0.32 | 0.37 |
| 1 | 3365 | YI (D1925) | 0.46 | 0.32 | 0.13 | −0.06 | −0.02 |
| 2 | PP/PIB | | 0.38 | 0.24 | 0.10 | −0.05 | 0.09 |

Overall, both films have similar colors, especially at higher temperatures. At lower temperatures from 140 to 145° C., the PP/PIB blend films showed slightly deeper yellow colors.

### Example 5

The barrier properties, specifically the oxygen transmittance rate (OTR) and the water vapor transmission rate (WVTR) of both samples from Example 1 were investigated for the film samples made at 145° C. Tensile tests were also performed on both samples. The results are tabulated in Table 6.

TABLE 6

| | | | Shrinkage | | Tensile Property-MD | |
|---|---|---|---|---|---|---|
| Sam- | | | at 125° C. | | Yield/Break | Elongation at |
| ples | WVTR | OTR | MD | TD | Strength (kpsi) | Yield/Break (%) |
| 1 | 0.55 | 169.9 | 2.94 | 2.94 | 28.52 ± 2.5 | 77.5 ± 17.7 |
| 2 | 0.62 | 187.1 | 1.96 | 1.96 | 28.62 ± 2.1 | 91.4 ± 9.7 |

Referring to Table 6, the WVTR and OTR for the PP/PIB blend with 2.4 wt. % PIB were slightly higher than that of the polypropylene homopolymer, 3365. The yield/break strength for both samples was similar, although the elongation at break for PP/PIB sample was higher than 3365. Additionally, the shrinkage at both MD and TD for PP/PIB blend was lower than that observed for the polypropylene homopolymer, 3365.

Polypropylene cast films containing 15 wt. % PIB displayed oxygen and water permeability that was decreased by 50% to 70%, significantly improving their barrier properties. Biaxially oriented polypropylene films are expected to possess similar barrier advantages when more PIB is present. Without wishing to be limited by theory, because PIB has a symmetry of the two methyl side groups on its backbone, the amorphous polymer chains can adhere closely to each other even at above its T_{g} temperature, resulting in an inherent gas impermeability. In PP films, the amorphous phases form pathways for gas permeation. When blending with small amounts of PIB, barrier improvement by PIB may be compromised with the lowered degree of PP crystallinity. However, when higher levels of PIB are present, the excellent barrier characteristics of the PIB components may become dominant relative to the decrease of PP crystallinity, improving the barrier properties of BOPP films.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A film prepared from a polypropylene and from 1 wt % to 10 wt % polyisobutylene blend wherein the film is prepared in the absence of a nucleator and has a stretching force that is reduced by about 5% to 200% when compared to an otherwise similar film prepared in the absence of polyisobutylene.

2. The film of claim 1 wherein the polypropylene comprises a polypropylene homopolymer, a high crystallinity polypropylene, or combinations thereof.

3. The film of claim 2 wherein the high crystallinity polypropylene has a meso pentad percentage of greater than 97%.

4. The film of claim 2 having a xylene soluble fraction of less than 1.5%.

5. The film of claim 1 wherein the polyisobutylene has a number average molecular weight of from 500 Daltons to 50,000 Daltons.

6. The film of claim 1 wherein the polyisobutylene has a polydispersity index of from 1.1 to 5.0.

7-9. (canceled)

10. An article formed from the film of claim 1.

11. The article of claim 10, wherein the article comprises a packaging container.

12. The film of claim 1 having a tensile strength at break of from 10 kpsi to 40 kpsi.

13. The film of claim 1 having a tensile elongation at break of from 10% to 200%.

14. The film of claim 1 having a haze percentage of from 0.1% to 5%.

15. The film of claim 1 having a gloss 45° of from 60% to 100%.

16. The film of claim 1 having a yellowness index of from −2 to 10.

17-18. (canceled)

19. The film of claim 8 having an oxygen transmission rate of from 20 to 200 cc/in²/24 hr.

20. The film of claim 8 having a water vapor transmission rate of from 0.1 to 1.0 g/100 in²/24 hr.

21. A method of producing film comprising:
contacting polypropylene and polyisobutylene to form a polymeric blend, forming the polymeric blend into a film; and
orienting the film, wherein the film is formed in the absence of a nucleator.

22. A film prepared from a polypropylene and polyisobutylene blend, wherein the polyisobutylene has a number average molecular weight of greater than 5,000 Daltons to 50,000 Daltons and the film has a stretching force that is reduced by about 5% to 200% when compared to an otherwise similar film prepared in the absence of polyisobutylene.

23. A film prepared from a polypropylene and polyisobutylene blend, wherein the polypropylene comprises high crystallinity polypropylene and the film has a stretching force that is reduced by about 5% to 200% when compared to an otherwise similar film prepared in the absence of polyisobutylene.
